(19) United States
(12) Patent Application Publication
(10) Pub. No.: US 2024/0338716 A1
(43) Pub. Date: Oct. 10, 2024

(54) SYSTEM FOR EXTRAPOLATING USER BEHAVIOR SIGNALS IN A DIGITAL ASSET MARKETPLACE USING DENSE VECTORS

(71) Applicant: Shutterstock, Inc., New York, NY (US)

(72) Inventor: Patrick Nicholson, Dublin (IE)

(21) Appl. No.: 18/314,981

(22) Filed: May 10, 2023

Related U.S. Application Data
(60) Provisional application No. 63/457,503, filed on Apr. 6, 2023.

(51) Int. Cl. G06Q 30/0202; G06Q 30/0204

(52) U.S. Cl. CPC G06Q 30/0202; G06Q 30/0205

(57) ABSTRACT

A method for finding digital assets in a database per a user query, is provided. The method includes generating an embedded keyword vector for a search query from a user searching for a digital asset in a database, ranking multiple embedded asset vectors within a similarity radius around the embedded keyword vector, each of the embedded asset vectors associated with a digital asset in the database based on a proximity with the embedded keyword vector, and providing, to the user, multiple digital assets associated with the embedded asset vectors in response to the search query, based on the ranking. A system including a memory circuit storing instructions and one or more processors configured to execute the instructions to cause the system to perform a method as above, the memory circuit and the one or more processors, are also provided.

### CROSS-REFERENCE TO RELATED APPLICATIONS

The present disclosure is related and claims priority under 35 U.S.C. § 119(e) to US Prov. Appln. No. 63/457,503, entitled SYSTEM FOR EXTRAPOLATING USER BEHAVIOR SIGNALS IN A DIGITAL ASSET MARKETPLACE USING DENSE VECTORS to Patrick NICHOLSON, filed on Apr. 6, 2023, the contents of which are hereby incorporated by reference, in their entirety, for all purposes.

### BACKGROUND

### Field

A system for extrapolating user behavior signals, stored during the usual daily operation of an online digital marketplace, to digital assets that have not yet been interacted by users is provided. User behavior signals may include actions like “purchase an asset,” “view an asset,” or “add asset to cart.”

### Related Art

Search engines typically use natural language processing (NLP) algorithms to classify digital assets (e.g., audio, video, images, and other multimedia files) in high-dimensional vector spaces having a sparse vector density (in view of their large dimensionality). Traditional search systems rank assets based on user interactions with those assets. However, most assets will have few, if any, historical user interactions. As a result, there is a cold start problem wherein newly uploaded assets have likely zero projection on relevant dimensions, and therefore lag in selection by the search engine. Additionally, most search engines today have extremely long tails of relevant search queries which lead to data sparsity problems. The sparsity of the vector space substantially reduces the accuracy and nuance of the engine, leading to results that are likely to be rejected by the users, or substantially depart from user desirability.

### SUMMARY

In a first embodiment, a computer-implemented method for finding digital assets in a database per a user query includes generating an embedded keyword vector for a search query from a user searching for a digital asset in a database. The computer-implemented method also includes ranking multiple embedded asset vectors within a similarity radius around the embedded keyword vector, each of the embedded asset vectors associated with a digital asset in the database based on a proximity with the embedded keyword vector, and providing, to the user, multiple digital assets associated with the embedded asset vectors in response to the search query, based on the ranking.

In a second embodiment, a system for handling user searches for digital assets in a database includes an online marketplace engine including a dense vector embedding tool and a user behavior signals tool, and a search engine comprising a scoring tool and a ranking tool. In the system, the dense vector embedding tool is configured to generate an embedded keyword vector for a user-provided search query to the search engine and embedded asset vectors for digital assets stored in a database, the scoring tool is configured to generate a score for each of the embedded asset vectors based on a one or more user behavior signals stored in the database by the user behavior signals tool, and the ranking tool is configured to rank the embedded asset vectors based on the score and a similarity radius with the embedded keyword vector.

In a third embodiment, a system includes a memory storing instructions, and one or more processors configured to execute the instructions to cause the system to perform operations. The operations include to generate an embedded keyword vector for a search query from a user searching for a digital asset in a database, to rank multiple embedded asset vectors within a similarity radius around the embedded keyword vector, each of the embedded asset vectors associated with a digital asset in the database based on a proximity with the embedded keyword vector, and to provide, to the user, multiple digital assets associated with the embedded asset vectors in response to the search query, based on the ranking.

These and other embodiments will become clear to one of ordinary skill in light of the following.

### BRIEF DESCRIPTION OF THE FIGURES

FIG. 1 illustrates a network architecture supporting an online digital asset marketplace, according to some embodiments.

FIG. 2 is a block diagram illustrating details of one or more devices used in the network architecture of FIG. 1, according to some embodiments.

FIG. 3 illustrates another block diagram illustrating devices and participants in an online digital asset marketplace, according to some embodiments.

FIG. 4 illustrates a sparse vector representation and a dense vector representation, according to some embodiments.

FIGS. 5A-5C illustrate neural network architectures used by a dense vector embedding tool to generate dense keyword vectors and dense asset vectors from sparse vectors, according to some embodiments.

FIG. 6 illustrates a reduced multi-dimensional space with dense vectors for scoring and ranking digital assets in response to a user query, according to some embodiments.

FIG. 7 is a flow chart illustrating steps in a method for embedding dense asset vectors for non-interacted assets from a database, according to some embodiments.

FIG. 8 is a flow chart illustrating steps in a method for finding digital assets in a database per a user query, according to some embodiments.

FIG. 9 is a block diagram illustrating details of a computer system used to implement one or more of the devices in the network architecture of FIG. 1.

In the figures, elements having the same or similar labels are associated with the same or similar attributes and features, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Traditional search engines use high-dimensionality spaces defining multiple attributes of digital assets, leading to sparse vectors. A sparse vector space results typically from a purely grammatical vectorization of text strings. Distances in such a sparse space tend to be extremely large and generally give little indication of a semantic similarity between objects associated to different points in the sparse space. Accordingly, searches are lengthy and cumbersome, and usually lead to wrong, or at best inexact, associations and rankings.

To resolve the above problem, an online digital marketplace as disclosed herein is an online marketplace resource for searching digital assets (e.g., audio, video, images, and other multimedia files), classified in a dense vector representation. The dense vector representation uses a semantic approach for embedding search queries, thus reducing the dimensionality of the classification space (still in the 100s or more, but much less than typical sparse vector spaces). User behavior signals may include any customer behavior that can be captured by the online digital marketplace, e.g., via web analytics tools that capture user interactions, not limited to, but exemplified by clicks and mouse movements in their web browser (scrolling, panning, zoom-in, zoom-out, and the like). One of the key operations in online digital marketplaces is ranking digital assets in user search results. Search result rankings desirably enhance user interactions with the returned search results. In some embodiments, the amount of purchasing or licensing events of the digital assets found through a search is maximized. There are two main problems within search ranking:

Ranking assets which are newly uploaded and have not yet been interacted with. The digital marketplace will be continuously receiving new assets from contributors, who upload new digital assets to the marketplace. These digital assets (e.g., videos, images, 3D models, music) have some associated metadata (a free text description, associated keywords, information about the camera/tools used to create the asset, etc.).

Ranking results for novel queries for which no behavioral signals have been recorded. Over time there will be novel queries, e.g., “covid 19,” “Evergiven,” and the like, that correspond to emerging concepts.

The disclosed system allows the online digital marketplace to derive scores, or predictions, for each “Search Query” and “Asset” pair (Q, A), indicative of the likelihood of users interacting with asset A, when they supply search query, Q. The scores can be used to rank search results for query Q. prioritizing those assets that are likely to be interacted with by the users. The disclosed embodiments solve the data sparsity for search queries, Q, in which a user has interacted with at least some prior assets. The system computes a score for how likely the user is to interact with, for example, a newly uploaded asset given the query context, Q. The disclosed system improves user interaction rates, and therefore enhances revenue for search engines and asset databases due to a more accurate and precise assessment of user interests by using a dense vector space for (Q, A) pairs.

In some embodiments, a system is provided for ranking assets which are new and have not yet been interacted with (e.g., the “cold start” problem), based on queries in which at least some user behavior signal has been captured in the past.

The system is highly scalable, and usable in an online digital marketplace that leverages either a) a traditional keyword-based search engine (e.g., sparse vector search), or b) a search engine that combines both dense and sparse vectors.

The system adapts organically to the custom language patterns and idioms used by the customers of the online digital marketplace. For example, if a word or phrase has been adopted by customers to have a particular meaning within the context of the digital marketplace, and this meaning differs from the common/average use of the word or phrase, the system is able to capture that nuanced information and adapt the meaning of the word to its usage in the marketplace.

The system does not require additional labeled data, feedback, or annotation, beyond the user behavior signals captured by the online digital marketplace.

The system is language agnostic, in that the same invention works in any language in which the digital asset marketplace operates.

The system can be adapted to serve regional (spatial or otherwise) demands by augmenting search queries with customer segmentation data.

### Example System Architecture

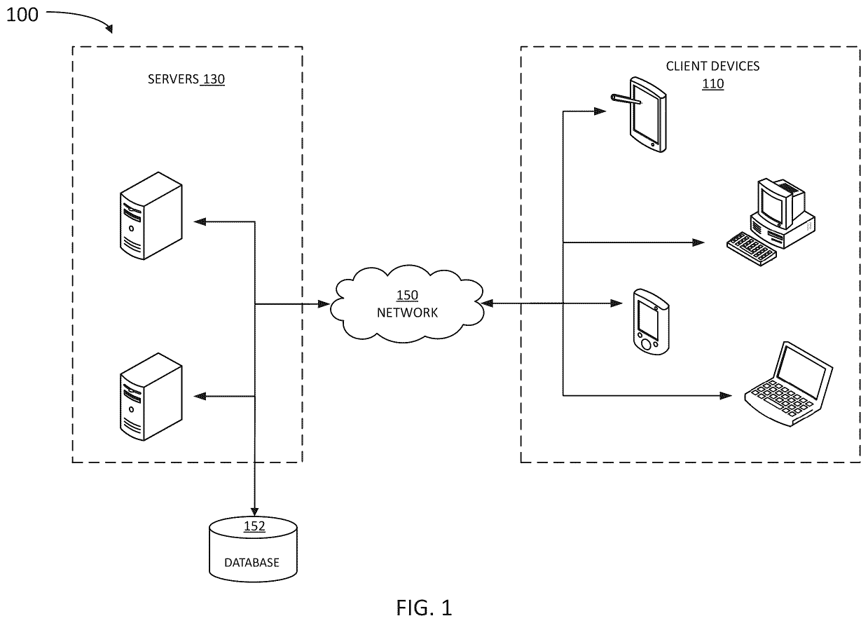

FIG. 1 illustrates a network architecture 100 supporting an online digital asset marketplace, according to some embodiments. Architecture 100 includes servers 130 communicatively coupled with client devices 110 over a network 150. One of the many servers 130 is configured to host a memory including instructions which, when executed by a processor, cause the server 130 to perform at least some of the steps in methods as disclosed herein. In some embodiments, the processor is configured to operate a search application in one of client devices 110. The search application may look for media files such as image files, video files, or audio files in a database 152 handled by a marketplace engine in one of servers 130. The user of client devices 110 may include a graphic designer or a document producer (e.g., a photographer, a videographer, an advertiser, and the like) downloading and/or uploading media files to the online marketplace. Accordingly, the server memory may include a marketplace engine and a search engine, configured to generate, maintain, and manage a data structure that uses dense vector embeddings for an accurate search. For purposes of load balancing, multiple servers 130 can host memories including instructions to one or more processors, and multiple servers 130 can host a user behavior database and a digital asset database. Accordingly, client devices 110 may communicate with each other via network 150 and through access to server 130 and resources located therein.

Servers 130 may include any device having an appropriate processor, memory, and communications capability for hosting the marketplace and search engines including multiple tools associated therewith. The marketplace and search engines may be accessible by various clients 110 over the network 150. Clients 110 can be, for example, desktop computers, mobile computers, tablet computers (e.g., including e-book readers), mobile devices (e.g., a smartphone or PDA), or any other devices having appropriate processor, memory, and communications capabilities for accessing the marketplace engine on one or more of servers 130. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

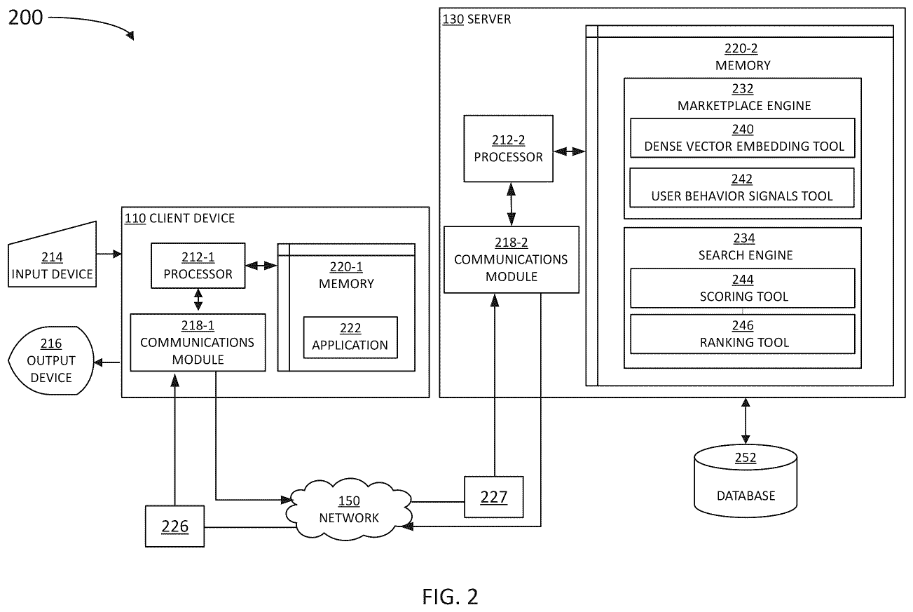

FIG. 2 is a block diagram 200 illustrating details of one or more devices used in the network architecture 100, according to some embodiments. Client device 110, server 130, and a database 252 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. A user may interact with client device 110 via an input device 214 and an output device 216. Input device 214 may include a mouse, a keyboard, a pointer, a touchscreen, a microphone, and the like. Output device 216 may be a screen display, a touchscreen, a speaker, and the like. Client device 110 may include a memory 220-1 and a processor 212-1. Memory 220-1 may include an application 222, configured to run in client device 110. Application 222 may be downloaded by the user from server 130 and may be hosted by server 130. Application 222 may include a graphic design application hosted by server 130 from which a user downloads or uploads images and other media files from and to any one of servers 130. Moreover, the user may access engines and tools in server 130, as described below. In some embodiments, the user may be a document producer and may upload a media file in a dataset 227 to marketplace engine 232. Similarly, server 130 may provide a media file in a dataset 226 to client device 110 as a result of a licensing or purchasing transaction. In some embodiments, dataset 226 may include a ranked list of search results in response to a search query received from the user (which search query may be included in dataset 227).

Server 130 includes a memory 220-2, a processor 212-2, and communications module 218-2. Hereinafter, processors 212-1 and 212-2, and memories 220-1 and 220-2 will be collectively referred to, respectively, as “processors 212” and “memories 220.” Processors 212 are configured to execute instructions stored in memories 220. In some embodiments, memory 220-2 includes a marketplace engine 232 and a search engine 234. Marketplace engine 232 and search engine 234 may share or provide features and resources to application 222, including multiple tools associated with navigating through an online marketplace and searching for media files therein. The user may access marketplace engine 232 and search engine 234 through application 222 or a web browser installed in a memory 220-1 of client device 110. Accordingly, application 222 may be installed by server 130 and perform scripts and other routines provided by server 130 through any one of multiple tools. Execution of application 222 may be controlled by processor 212-1. Marketplace engine 232 may include a dense vector embedding tool 240 and a user behavior signals tool 242. And search engine 234 may include a scoring tool 244 and a ranking tool 246.

Dense vector embedding tool 240 computes dense vectors for digital assets and stores them in database 252. Dense vectors are a geometrical representation of a digital asset or query in a multidimensional space wherein each dimension indicates a semantic classifier or attribute. In some embodiments, dense vector embedding tool 240 computes a weighted mean of the dense vectors of digital assets that were purchased, in the past, for a selected query. For example, to create the dense vector for the query “dog,” dense vector embedding tool 240 would look in database 252 at digital assets purchased after users had searched for “dog.” Each digital asset has a “purchase count” and may be in turn associated with a dense vector (e.g., at the time the digital asset was uploaded to database 252 by its creator). Dense vector embedding tool 240 computes the weighted mean—e.g., weighted by purchase count—of the digital asset vectors to generate a dense keyword vector for the keyword “dog.”

In some embodiments, dense vector embedding tool 240 identifies clusters of vectors to represent the different degrees or conceptual variances of a given attribute in the multi-dimensional space. For example, for the query “dog,” dense vector embedding tool 240 may identify different clusters indicative of different dog breeds. Accordingly, dense vector embedding tool 240 produces a one-to-many relationship between queries and dense vectors. This would further allow scoring tool 244 and ranking tool 246 to sort search results according to proximity to the search keywords in the multi-dimensional space. In addition to proximity, as defined by a cosine distance, scoring tool 244 and ranking tool 246 may assign scores and ranking based on directions defined by the difference between the keyword vector and a given set of asset vectors in the multi-dimensional space.

In some embodiments, user behavior signals tool 242 may provide input that may be valuable to filter outliers, ensure coherence in the output dense vectors, and further fine tune the performance of the output dense vectors from vector embedding tool 240. For example, user reactions upon entering a given query may be registered on a camera, or the keyboard or touchscreen, indicating a clear signal of like or dislike from the user, which can be used by scoring tool 244 to filter the associated keyword vector appropriately.

In some embodiments, marketplace engine 232 may preprocess search queries to handle issues of stemming (e.g., classifying according to a semantic concept chain). A simple example may include geolocation data to find UK/US localization synonyms, when the user enters queries in English.

In addition to generating dense keyword vectors and dense asset vectors for assets that users have interacted with, dense vector embedding tool 240 may extrapolate user behavior information to digital assets that have not yet been interacted with and provide accurate dense vectors for those assets too.

In some embodiments, scoring tool 244 may operate in a search engine 234 that is configured for sparse vectors only. In this configuration, metadata for digital assets keywords can either come from the contributors, or be derived from other ML services. For each keyword, the system computes a similarity between the dense vector associated with that keyword (e.g., search query) and the dense vector associated with one or more digital assets that users have interacted with. Scoring tool 244 then generates, for each digital asset in database 252, a scored list of keywords, which can then be indexed by ranking tool 246. In some embodiments, scoring tool 244 scores the keywords according to the user behavior that went into creating the dense vectors for the search keywords, as provided by user behavior signals tool 242. Thus, scoring tool 244 extrapolates user behavior to digital assets that have been recently uploaded to database 252 and have no prior user interaction data. Ranking tool 246 can index the scores associated with the keywords, and incorporate these scores into its ranking formula, either in an unsupervised way, or using learning-to-rank algorithms.

When search engine 234 can handle both sparse and dense vectors, scoring tool 244 performs a “semantic search” or K-nearest neighbors search using the embedded keyword vector provided by dense vector embedding tool 240. In some embodiments, ranking tool 246 includes a tunable parameter that indicates how much of the ranking should be based on the dense vector representation (associated with the embedded keyword vector, as described above) and on a sparse vector representation. Note that the dense vector representation and the sparse vector representation may have very different dimensionality, and thus very different similarity measures (e.g., cosine distances). Accordingly, in some embodiments, ranking tool 246 may weight in the different scales between sparse vector space distances (larger) and dense vector space distances (smaller).

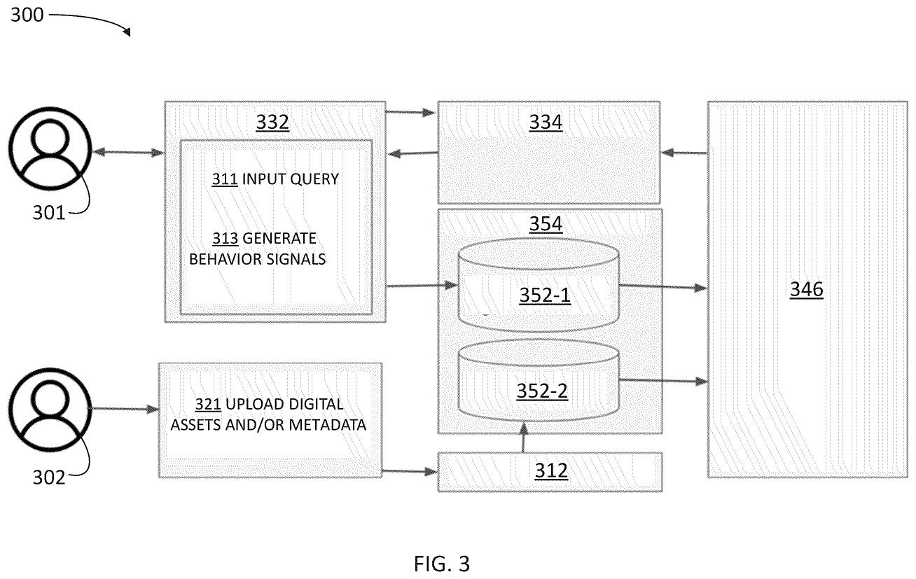

FIG. 3 illustrates another block diagram 300 illustrating devices and participants in an online digital asset marketplace 332, according to some embodiments. Block diagram 300 illustrates how data flows in a system architecture, according to some embodiments. A front-end system serving asset consumer 301 includes online digital marketplace 332, and contains a website, a mobile application, a desktop application, or APIs with which asset consumer 301 interacts. A data warehouse 354 stores asset metadata and analytics data to allow downstream analysis.

Data warehouse 354 includes a user behavior signals database 352-1 wherein the user behavior is recorded 313, along with the context (the search query supplied by consumer 301 that led to the action). User behavior signals are generated when asset consumer 301 performs an action, such as purchasing, licensing, downloading, adding to cart, or otherwise viewing or hovering over a digital asset. User behavior database 352-1 captures user interactions with the front-end system, and provides context such as: event time, search query context (what was the search query the user had issued before the behavior event), geolocation information (e.g., customer country, language, and the like), and any other user segmentation data, such as customer segmentation information (e.g., information to delineate whether the user is a corporate entity/high volume user, personal/low volume user, and the like). Data warehouse 354 also includes a metadata database 352-2 that contains relevant metadata for a particular digital asset, as well as any derived metadata or dense vectors (created by the asset processor).

The search engine module is the back-end system that allows asset consumers to query the digital asset marketplace to find assets that are most relevant to their query. The search engine module can be an in-house system, managed service, and/or utilize open-source technologies. For our system, the search engine can either be based on a traditional sparse vector approach, or a combination of sparse +dense vector approach.

An asset consumer 301, or digital asset customer, visits online digital marketplace 332 and enters search queries 311 into the search engine 334 coupled with online digital marketplace 332. The session of consumer 301 ends when asset consumer 301 either leaves the website for online digital marketplace 332, or purchases/licenses a digital asset from online digital marketplace 332.

An asset producer 302, or contributor, produces and uploads digital assets 321, to data warehouse 354. In some embodiments, asset producer 302 includes photographers/videographers and graphic designers who upload their photos/videos along with description metadata. The description metadata typically includes a short free text description of the photo/video content, as well as a set of up to 50 keywords, and is stored in asset metadata database 352-2. The purpose of this metadata is to allow the digital asset to be surfaced during a subsequent search by asset consumer 301. In some embodiments, asset metadata may be provided by asset producers in English, but this is not a limitation, and the system can work in any given language. An asset processor 312 uploads the digital asset and the associated metadata into database 352-2.

Asset producer 302 uploads their digital assets into database 352-2, to allow digital assets to be found, viewed, and purchased by consumer 301 accessing online digital marketplace 332. In some embodiments, the asset may or may not include additional metadata beyond the digital asset itself. For example, the asset metadata may include a short text description of the asset, a list of relevant keywords, or other data about the tools used to create the asset. In the specific case where the digital asset includes photos or videos, the asset metadata may include technical specifications regarding the camera that was used to take the photo or video.

Asset processor 312 may further derive additional data/metadata to be stored with the asset in database 352-2. An example of this metadata may be keywords inferred by a machine learning algorithm or SaaS offering, or in-house algorithms developed for this task. In some embodiments, asset processor 312 creates at least one dense vector to represent the digital asset (e.g., “embeddings”). In some embodiments, the embeddings for one type of media (e.g., videos) may be in a different registry of database 352-2 as embeddings for other types of media (e.g., music). In some embodiments, dense vector space embeddings for different media types may be assigned the same registry in database 352-2.

A user behavior database ranking module 346 produces an index for ranking assets with user behavior signals in user behavior signals database 352-1. In some implementations, user-behavior database ranking module 346 resides within data warehouse 354. In some embodiments, user behavior database ranking module 346 computes, for each search query that has resulted in a desired user behavior, a dense vector to represent that search query. For illustrative purposes, a single behavior—purchasing an asset—may be selected. More generally, the system can convert different user behaviors into independent signals that could in turn be combined in different forms and permutations. Some embodiments may include a linear combination of the signals with pre-defined weights. Some embodiments may include learning the weights using machine learning (e.g., learning to rank frameworks).

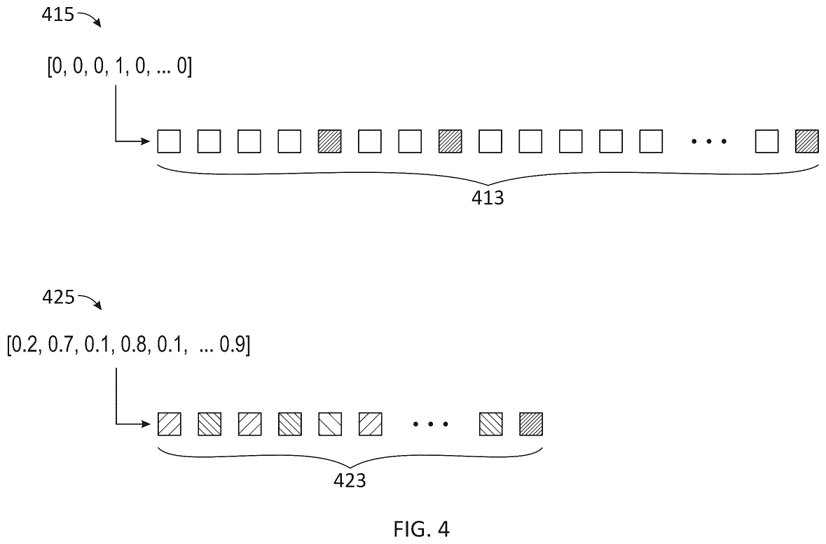

FIG. 4 illustrates a sparse vector representation 415 and a dense vector representation 425, for the same digital asset, according to some embodiments. A dimensionality 413 of sparse representation 415 may be hundreds of thousands or millions (e.g., 2M, or even more). A dimensionality 423 of dense representation 425 may be much lower, although still sufficiently high (e.g., several hundred, such as 700, or even more). Sparse representation 415 is associated with specific syntaxis, and thus contains a large number of entries that are zero, and only a few ones corresponding to each of the words in a query. Instead, dense representation 425 is associated with a semantic context of a keyword, and thus few values are zero or one. Rather, a distribution of fractional values cover a range between zero and one, indicating a similarity of the keyword in the search query to a given keyword in a reduced dimensionality space.

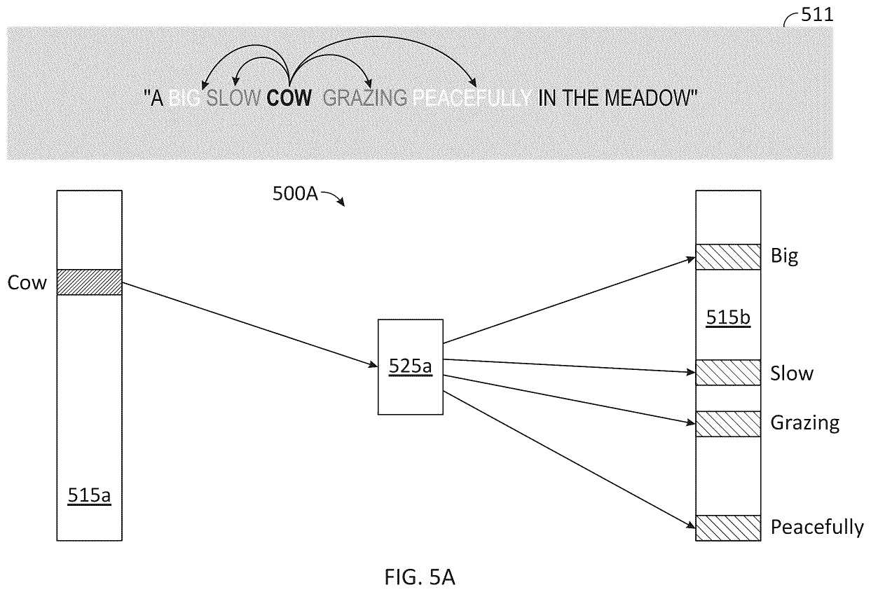

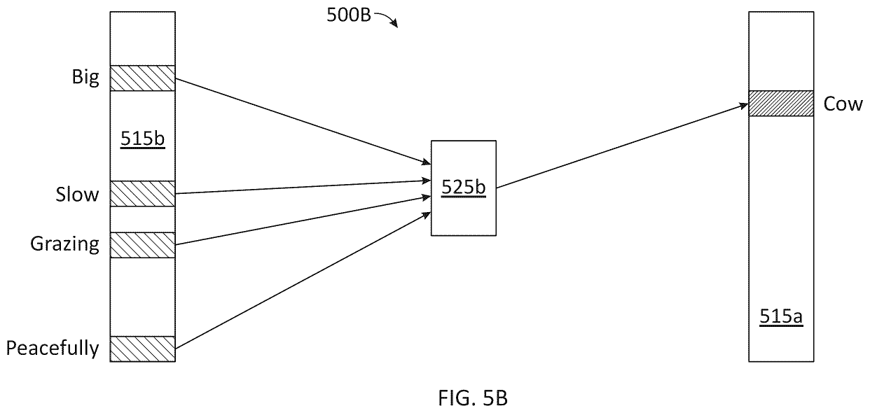

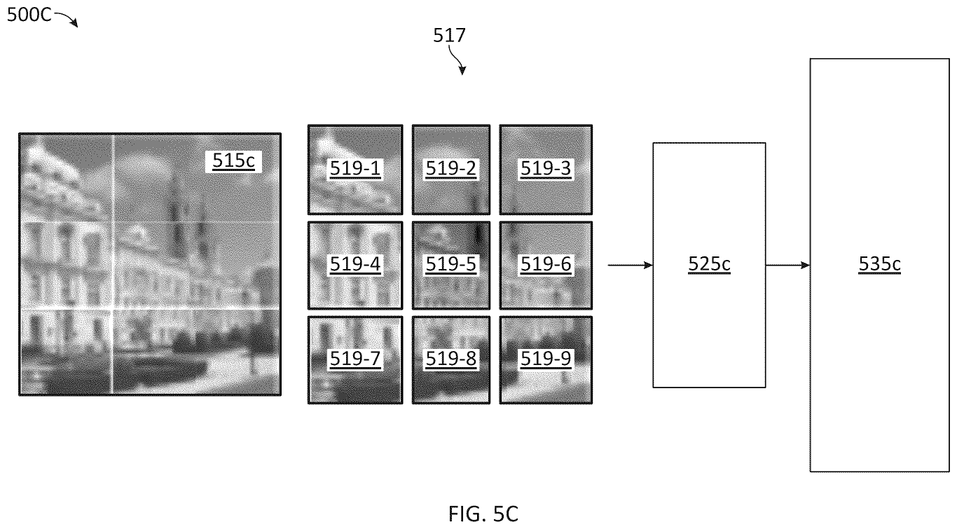

FIGS. 5A-5C illustrate neural network (NNs) architectures 500A, 500B, and 500C (hereinafter, collectively referred to as “NNs 500”), used by a dense vector embedding tool to generate dense keyword vectors 525a, 525b, and dense asset vectors 525c (hereinafter, collectively referred to as “dense vectors 525”) from sparse text vectors 515a and 515b, or an image vector 515c, according to some embodiments.

NNs 500A and 500B are associated with a text string 511 “A BIG SLOW COW GRAZING PEACEFULLY IN THE MEADOW.” Some embodiments may first map search queries to text embeddings, then create “search keyword vectors” using those embeddings as illustrated by NN 500A and NN 500B. NN 500A starts with the keyword “cow” in a sparse vector 515a, which is encoded into convoluted layer 525a, and then decoded into a sparse vector 515b including the words “big,” “slow,” “grazing,” and “peacefully.” NN 500B performs the reverse encoding decoding scheme, from sparse vector 515b into sparse vector 515a. Convoluted layers 525a and 525b are a reduced dimensionality representation of sparse vectors 515a and 515b, e.g., dense vector representations thereof.

NN 500C is a convolutional neural network taking image 515c into a convoluted layer 525c before decoding the image into a classification map 535c. A fragmented version 517 splits image 515c into fragments 519-1, 519-2, 519-3, 519-4, 519-5, 519-6, 519-7, 519-8, and 519-9 (hereinafter, collectively referred to as “fragments 519”) that are coded with a spatial location indicative of the portion from image 515c where each fragment 519 belongs. Convoluted layer 525c includes all the information in image 515c, including the location information of each portion 519. Accordingly, convolutional layer 525c is a reduced dimensionality representation of image 515c, e.g., a dense vector representation thereof.

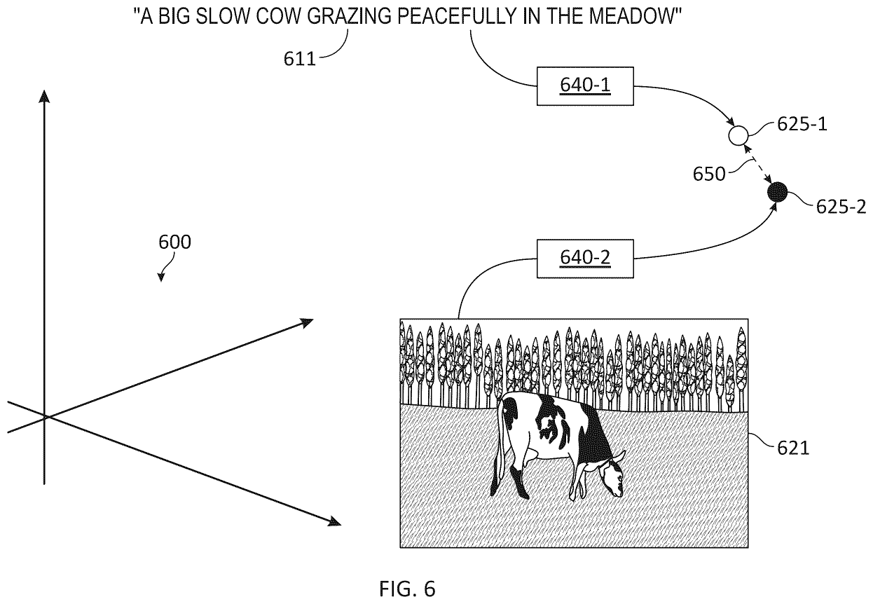

FIG. 6 illustrates a reduced multi-dimensional space 600 with embedded keyword vector 625-1 and embedded asset vector 625-2 (hereinafter, collectively referred to as “embedded vectors 625”) for scoring and ranking digital assets 621 in response to a user query 611, according to some embodiments. Embedded keyword vector 625-1 is provided by a first vector embedding tool 640-1 from query 611. And embedded asset vector 625-2 is provided by a second embedding tool 640-2 from digital asset 621. Vector embedding tools 640-1 and 640-2 will be collectively referred to, hereinafter, as “vector embedding tools 640.” In some embodiments, vector embedding tools 640 may be part of the same marketplace engine (cf. dense vector embedding tool 240 in marketplace engine 232).

A distance 650 separating embedded vectors 625 in multi-dimensional space 600 is used to score and rank embedded asset vector 625-2 for a given embedded keyword vector 625-1. The system presents the digital assets associated with the ranked embedded asset vectors 625-2 to the user, as a result of query 611.

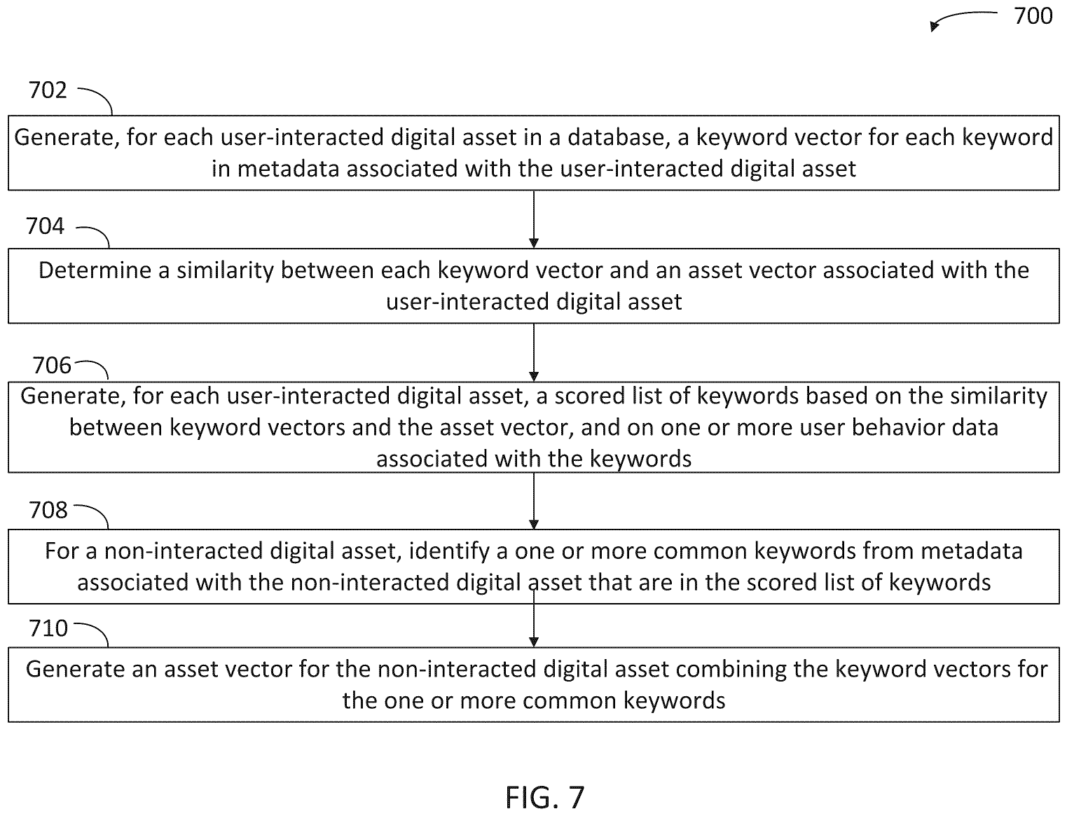

FIG. 7 is a flow chart illustrating steps in a method 700 for embedding dense asset vectors for non-interacted assets from a database, according to some embodiments. At least one or more of the steps in method 700 may be performed by a computer system in a client device or a server, the client device and the server being communicatively coupled through a network via a communications module (e.g., client device 110, server 130, network 150, and communications modules 218). The computer system may include a memory storing instructions which, executed by a processor, perform at least partially one or more of the steps in method 700 (e.g., processors 212 and 312, and memories 220). In some embodiments, one or more steps in method 700 is at least partially executed by an application installed in the client device and hosted by a marketplace engine and a search engine in the server (e.g., application 222, marketplace engines 232 and 332, and search engines 234 and 334). Further, in some embodiments, one or more of the steps in method 700 may be performed by a dense vector embedding tool, a user behavior signal tool, a scoring tool, and a ranking tool (e.g., dense vector embedding tool 240, user behavior signals tool 242, scoring tool 244, and ranking tool 246). Further, in some embodiments, data and information used in, or generated by, at least one of the steps in method 700 may be stored in a database communicatively coupled to, and hosted by, the server (e.g., databases 252 and 352, and data warehouse 354). Methods consistent with the present disclosure may include at least one or more of the steps in method 700 performed in a different order. For example, in some embodiments, steps in method 700 may be performed simultaneously, quasi-simultaneously, or overlapping in time.

Step 702 includes generating, for each user-interacted digital asset in a database, a keyword vector for each keyword in metadata associated with the user-interacted digital asset. In some embodiments, step 702 includes generating the keyword vector by taking a weighted average of asset vectors of the assets that were interacted with.

Step 704 includes determining a similarity between each keyword vector and an asset vector associated with the user-interacted digital asset.

Step 706 includes generating, for each user-interacted digital asset, a scored list of keywords based on the similarity between keyword vectors and the asset vector, and on one or more user behavior data associated with the keywords.

Step 708 includes, for a non-interacted digital asset, identifying one or more common keywords from metadata associated with the non-interacted digital asset that are in the scored list of keywords.

Step 710 includes generating an asset vector for the non-interacted digital asset combining the keyword vectors for the one or more common keywords.

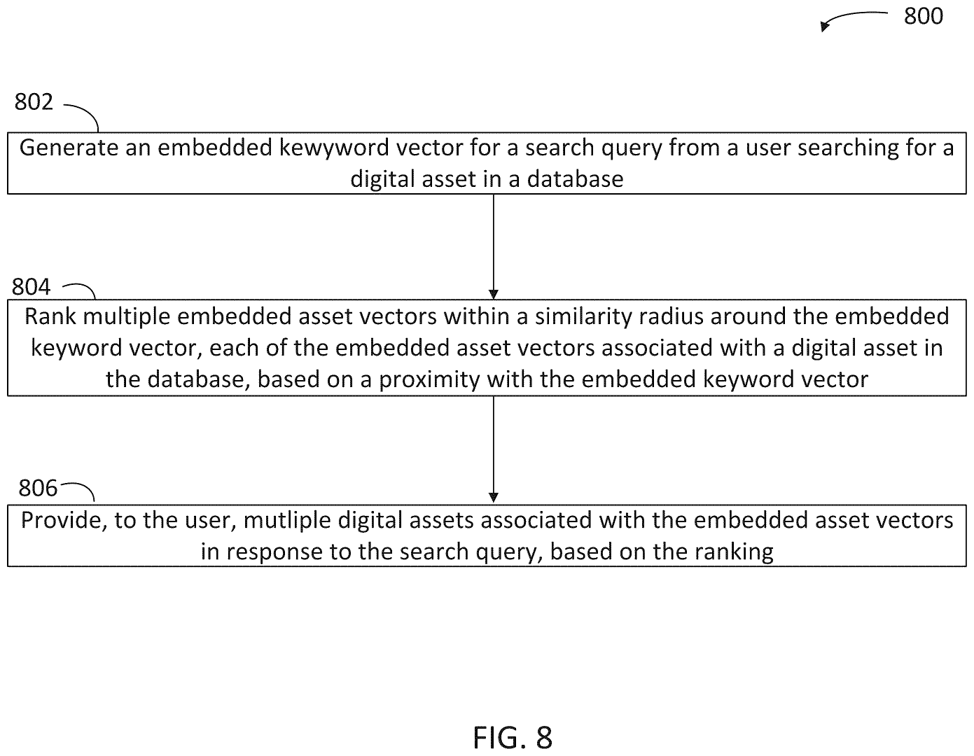

FIG. 8 is a flow chart illustrating steps in a method 800 for finding digital assets in a database per a user query, according to some embodiments. At least one or more of the steps in method 800 may be performed by a computer system in a client device or a server, the client device and the server being communicatively coupled through a network via a communications module (e.g., client device 110, server 130, network 150, and communications modules 218). The computer system may include a memory storing instructions which, executed by a processor, perform at least partially one or more of the steps in method 800 (e.g., processors 212 and 312, and memories 220). In some embodiments, one or more steps in method 800 is at least partially executed by an application installed in the client device and hosted by a marketplace engine and a search engine in the server (e.g., application 222, marketplace engines 232 and 332, and search engines 234 and 334). Further, in some embodiments, one or more of the steps in method 700 may be performed by a dense vector embedding tool, a user behavior signal tool, a scoring tool, and a ranking tool (e.g., dense vector embedding tool 240, user behavior signals tool 242, scoring tool 244, and ranking tool 246). Further, in some embodiments, data and information used in, or generated by, at least one of the steps in method 800 may be stored in a database communicatively coupled to, and hosted by, the server (e.g., databases 252 and 352, and data warehouse 354). Methods consistent with the present disclosure may include at least one or more of the steps in method 800 performed in a different order. For example, in some embodiments, steps in method 800 may be performed simultaneously, quasi-simultaneously, or overlapping in time.

Step 802 includes generating an embedded keyword vector for a search query from a user searching for a digital asset in a database. In some embodiments, step 802 includes identifying a cluster of embedded keyword vectors associated with multiple semantic extensions of a keyword in the search query and selecting the embedded keyword vector from the cluster of embedded keyword vectors. In some embodiments, step 802 includes selecting a semantic extension of a keyword in the search query based on a geolocation of the user. In some embodiments, step 802 includes selecting a semantic extension of a keyword in the search query based on a keyword synonym.

Step 804 includes ranking multiple embedded asset vectors within a similarity radius around the embedded keyword vector, each of the embedded asset vectors associated with a digital asset in the database, based on a proximity with the embedded keyword vector. In some embodiments, step 804 includes scoring the embedded asset vectors based on a digital asset metadata from a digital asset provider. In some embodiments, step 804 includes scoring the embedded asset vectors based on a user interaction with at least one digital asset associated with the embedded asset vectors. In some embodiments, step 804 includes scoring the embedded asset vectors based on a user behavior data stored in the database.

Step 806 includes providing, to the user, multiple digital assets associated with the embedded asset vectors in response to the search query, based on the ranking. In some embodiments, step 806 includes generating, for a digital asset, an embedded asset vector based on a one or more keywords associated with the digital asset, and a user interaction with the digital asset associated with each of the one or more keywords. In some embodiments, step 806 includes generating, for a digital asset, an embedded asset vector based on a weighted average of one or more embedded keyword vectors, each embedded keyword vector derived from a keyword associated with the digital asset and scored according to a user interaction with a second digital asset from the database associated with a same keyword. In some embodiments, step 806 includes evaluating a weighted average of multiple asset vectors based on a user interaction with each digital asset associated with the embedded asset vectors in response to the search query.

### Hardware Overview

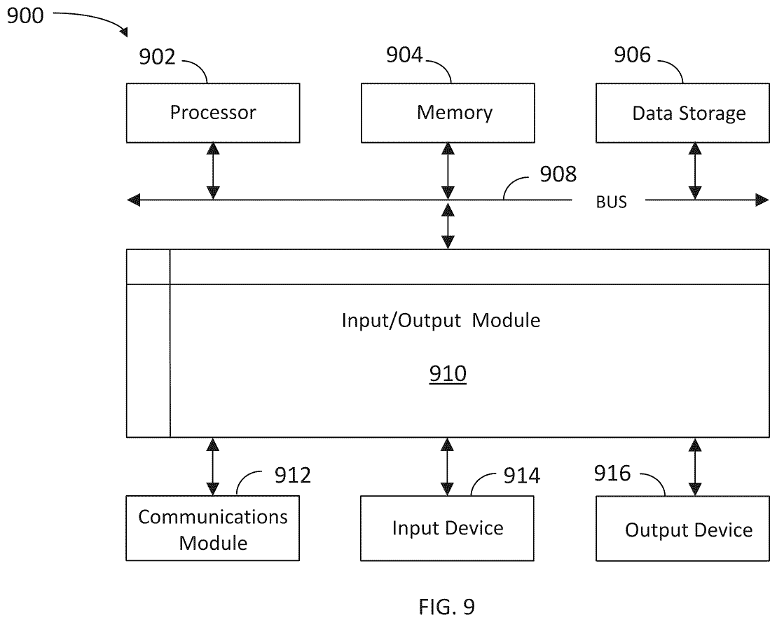

FIG. 9 is a block diagram illustrating an exemplary computer system 900 with which the client and server of FIGS. 1, 2, and 3, and the methods of FIGS. 7 and 8 can be implemented. In certain aspects, the computer system 900 may be implemented using hardware or a combination of software and hardware, either in a dedicated server, or integrated into another entity, or distributed across multiple entities.

Computer system 900 (e.g., client 110 and server 130) includes a bus 908 or other communication mechanism for communicating information, and a processor 902 (e.g., processors 212) coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. Input/output module 910 can be any input/output module. Exemplary input/output modules 910 include data ports such as USB ports. The input/output module 910 is configured to connect to a communications module 912. Exemplary communications modules 912 (e.g., communications modules 218) include networking interface cards, such as Ethernet cards and modems. In certain aspects, input/output module 910 is configured to connect to a plurality of devices, such as an input device 914 (e.g., input device 214) and/or an output device 916 (e.g., output device 216). Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 916 include display devices, such as an LCD (liquid crystal display) monitor, for displaying information to the user.

According to one aspect of the present disclosure, the client 110 and server 130 can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication tool (e.g., network 150) can include, for example, any one or more of a LAN, a WAN, the Internet, and the like. Further, the communication tool can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
generating an embedded keyword vector for a search query from a user searching for a digital asset in a database;
ranking multiple embedded asset vectors within a similarity radius around the embedded keyword vector, each of the embedded asset vectors associated with a digital asset in the database based on a proximity with the embedded keyword vector; and
providing, to the user, multiple digital assets associated with the embedded asset vectors in response to the search query, based on the ranking.

2. The computer-implemented method of claim 1, wherein generating an embedded keyword vector from a search query comprises identifying a cluster of embedded keyword vectors associated with multiple semantic extensions of a keyword in the search query, and selecting the embedded keyword vector from the cluster of embedded keyword vectors.

3. The computer-implemented method of claim 1, wherein generating an embedded keyword vector from a search query comprises selecting a semantic extension of a keyword in the search query based on a geolocation of the user.

4. The computer-implemented method of claim 1, wherein generating an embedded keyword vector from a search query comprises selecting a semantic extension of a keyword in the search query based on a keyword synonym.

5. The computer-implemented method of claim 1, wherein ranking multiple embedded asset vectors comprises scoring the embedded asset vectors based on a digital asset metadata from a digital asset provider.

6. The computer-implemented method of claim 1, wherein ranking multiple embedded asset vectors comprises scoring the embedded asset vectors based on a user interaction with at least one digital asset associated with the embedded asset vectors.

7. The computer-implemented method of claim 1, wherein ranking multiple embedded asset vectors comprises scoring the embedded asset vectors based on a user behavior data stored in the database.

8. The computer-implemented method of claim 1, further comprising generating, for a digital asset, an embedded asset vector based on a one or more keywords associated with the digital asset, and a user interaction with the digital asset associated with each of the one or more keywords.

9. The computer-implemented method of claim 1, further comprising generating, for a digital asset, an embedded asset vector based on a weighted average of one or more embedded keyword vectors, each embedded keyword vector derived from a keyword associated with the digital asset and scored according to a user interaction with a second digital asset from the database associated with a same keyword.

10. The computer-implemented method of claim 1, wherein generating an embedded keyword vector from a search query comprises evaluating a weighted average of multiple asset vectors based in a user interaction with each digital asset associated with the embedded asset vectors in response to the search query.

11. A system, comprising:
an online marketplace engine including a dense vector embedding tool and a user behavior signals tool; and
a search engine comprising a scoring tool and a ranking tool, wherein:
the dense vector embedding tool is configured to generate an embedded keyword vector for a user-provided search query to the search engine and embedded asset vectors for digital assets stored in a database,
the scoring tool is configured to generate a score for each of the embedded asset vectors based on a one or more user behavior signals stored in the database by the user behavior signals tool, and
the ranking tool is configured to rank the embedded asset vectors based on the score and a similarity radius with the embedded keyword vector.

12. The system of claim 11, wherein the user behavior signals tool is configured to log a user interaction with one or more digital assets, the user interaction including at least one of a purchase or lease of the digital asset, or a placement of the digital asset in a shopping cart, or hovering over a digital asset thumbnail.

13. The system of claim 11, wherein the user behavior signals tool is configured to log a user interaction when a user enters a search query, including a search query context, a time and a geolocation for the user when entering the search query, and a user segmentation data.

14. The system of claim 11, wherein the dense vector embedding tool is configured to generate an embedded asset vector based on a metadata file created by an asset producer when uploading a digital asset to the database, wherein the metadata file includes one or more keywords descriptive of a digital asset content.

15. The system of claim 11, wherein the dense vector embedding tool is configured to generate an embedded asset vector having a dimensionality depending on a type of digital asset associated with the embedded asset vector.

16. The system of claim 11, wherein the dense vector embedding tool computes, for each search query that has resulted in a desired user behavior, a dense vector to represent that search query.

17. The system of claim 11, wherein the scoring tool generates a score for an embedded asset vector based on a weighted average of the one or more user behavior signals.

18. The system of claim 11, wherein the dense vector embedding tool is configured to generate an embedded keyword vector based on a weighted average of multiple embedded asset vectors associated with digital assets that users have interacted with.

19. The system of claim 11, wherein the dense vector embedding tool is configured to generate an embedded asset vector from a digital image by splitting the digital image into multiple patches and encoding the patches with a position vector into a keyword classifier.

20. The system of claim 11. wherein the dense vector embedding tool is configured to generate an embedded asset vector of a video file by adding multiple embedded image vectors from different frames of a video asset.
